(19) United States
(12) Patent Application Publication
(10) Pub. No.: US 2006/0133518 A1
(43) Pub. Date: Jun. 22, 2006

(54) Methods for providing communications services

(76) Inventors: Randy Zimler, Gainesville, GA (US); Craig L. Cook, Birmingham, AL (US); Rhonda P. Hannon-Holland, Mount Juliet, TN (US); Geneva D. Boyd, Hartselle, AL (US)

Correspondence Address: SCOTT P. ZIMMERMAN, PLLC, PO BOX 3822, CARY, NC, 27519, US

(21) Appl. No.: 11/293,522

(22) Filed: Dec. 2, 2005

Related U.S. Application Data
(63) Continuation-in-part of application No. 10/743,358, filed on Dec. 22, 2003.
(63) Continuation-in-part of application No. 11/223,604, filed on Sep. 9, 2005.
(60) Provisional application No. 60/633,326, filed on Dec. 3, 2004.

(51) Int. Cl. H04L 25/00

(52) U.S. Cl. 375/257

(57) ABSTRACT

Methods, systems, and products are disclosed for providing communications services. A first physical medium and a second physical medium are logically bonded. Those logically bonded physical mediums are then associated in a database.

### CROSS-REFERENCE TO RELATED APPLICATIONS

This application is a continuation-in-part of U.S. patent application Ser. No. 10/743,358, filed Dec. 22, 2003, entitled “Methods of Providing Communications Services” (Attorney Docket BS01098), and incorporated herein by reference. This application is also a continuation-in-part of U.S. patent application Ser. No. 11/223,604, filed Sep. 9, 2005, entitled “Methods for Providing Communications Services” (Attorney Docket BS01098 CIP), and incorporated herein by reference in its entirety. This application also claims the benefit of U.S. Provisional Patent Application 60/633,326, filed Dec. 3, 2004, entitled “Internet Protocol Television Service” (Attorney Docket BS040428 Prov), and incorporated herein by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to digital communications and, more particularly, to expanding bandwidth in communications systems using multiple physical mediums.

Communications customers need more bandwidth. As more and more customers utilize advanced communications services including “video-on-demand” applications, more and more data must be transmitted along twisted cable pairs, coaxial cables, fiber optic lines, and/or whatever medium is available. This video-on-demand service can require upwards of 3 megabits per second of data with a standard television format, while a High-Definition Television (HDTV) format might require a minimum of 16 megabits per second of data. A Digital Subscriber Line, however, is generally limited to a download data rate of 1.5 megabits per second. Even with advanced video compression techniques, such as ITU H.264 (MPEG 4, Part 10), Digital Subscriber Lines, coaxial cables, and even some fiber optic installations cannot provide enough bandwidth to support these advanced broadband-intensive communications services, such as the video-on-demand service. There is, accordingly, a need in the art for methods and systems of increasing the bandwidth capacity of physical mediums to support advanced broadband-intensive communications services.

### SUMMARY

The aforementioned problems, and other problems, are reduced by a methods, systems, and products for bonding additional physical mediums to increase data rates. When a communications customer requests a broadband-intensive communications service (such as downloading movies or other high-bandwidth media content), the exemplary embodiments physically and logically bond at least second physical medium to provide additional bandwidth. This second physical medium is physically connected to the customer's premises and provides additional bandwidth. The exemplary embodiments then associate those bonded physical mediums in a database. That association, between the bonded physical mediums, is also maintained throughout a service order provisioning system. The bonded association, for example, may be maintained in a service order parser and controller system (such as Telcordia's SOAC system). This service order parser and controller system may be an interface that analyzes and parses a service order to determine any involvement of other applications. The service order parser and controller system may also direct an appropriate selection of a loop facility and a central office facility. The bonded association may also be maintained in a loop facilities system (such as Tekmark's LFACS®), a switching system (such as Telecordia's SWITCH® system), in an engineering and information system (such as Telcordia's LEIS® and GRANITE®), in a maintenance operations system (such as Telcordia's LMOS®), and/or in any reporting system. Exemplary embodiments thus introduce the concepts of bonding to these supporting systems, and exemplary embodiments describe how these systems are enhanced to recognize and maintain bonded associations. Exemplary embodiments, for example, associate and maintain bonded relationships for service orders, for maintenance changes, or for pair moves, for engineering work orders, and for any other operations.

Exemplary embodiments disclose a method for providing communications services. At least a first physical medium and a second physical medium are logically bonded. The logically bonded first and second physical mediums are associated in a database.

Exemplary embodiments also describe a system for providing communications services. The system includes a communications module stored in memory, and a processor communicates with a user interface stored in memory. The processor logically bonds at least a first physical medium and a second physical medium. The processor associates the logically bonded first physical medium and the second physical medium in a database.

Still more exemplary embodiments describe a computer program product for providing communications services. The computer program product comprises computer-readable instructions for logically bonding at least a first physical medium and a second physical medium. More computer-readable instructions associate the logically bonded first and second physical mediums in a database.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating the exemplary embodiments;

FIG. 2 is a schematic illustrating a Digital Subscriber Line (DSL) environment, according to the exemplary embodiments;

FIG. 3 is detailed schematic showing n multiple physical media, according to still more exemplary embodiments;

FIG. 4 is a block diagram showing a communications module residing in a computer system, according to the exemplary embodiments;

FIG5. 5 is a flowchart illustrating a method of providing communications services, according to the exemplary embodiments;

FIG. 6 is a flowchart illustrating another method of providing communications services, according to the exemplary embodiments;

FIG. 7 is a flowchart illustrating yet another method of providing communications services, according to the exemplary embodiments;

FIG. 8 is a schematic illustrating on-demand management of bonded physical mediums, according to more exemplary embodiments;

FIG. 9 is a schematic illustrating another operating environment for exemplary embodiments;

FIG. 10 is a schematic illustrating a Digital Subscriber Line (DSL) operating environment, according to more exemplary embodiments;

FIG. 11 is a schematic illustrating a bonded association in a service order process, according to still more exemplary embodiments;

FIG. 12 is a schematic illustrating provisions for facility optimization, according to even more exemplary embodiments;

FIG. 13 is a schematic illustrating provisions for facility optimization, according to even more exemplary embodiments;

FIG. 14 is a schematic illustrating provisions for identifying spare facilities, according to exemplary embodiments;

FIG. 15 is a schematic illustrating provisions for maintaining bonded facilities in the engineering work order system, according to even more exemplary embodiments; and

FIG. 16 is a schematic illustrating provisions for tagging bonded facilities, according to still more exemplary embodiments.

### DETAILED DESCRIPTION

The exemplary embodiments now will be described more fully hereinafter with reference to the accompanying drawings. The reader should recognize, however, that exemplary embodiments may have many different forms and should not be construed as limited to the embodiments set forth herein. These embodiments are provided so that this disclosure will be thorough and complete and will fully convey to those of ordinary skill in the art. Moreover, all statements herein reciting exemplary embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Functions may be carried out through the operation of program logic, through dedicated logic, through the interaction of program control and dedicated logic, or even manually, the particular technique being selectable by exemplary embodiments. Those of ordinary skill in the art further understand that the exemplary hardware, software, processes, methods, and/or operating systems described herein are for illustrative purposes and, thus, are not intended to be limited to any particular named manufacturer.

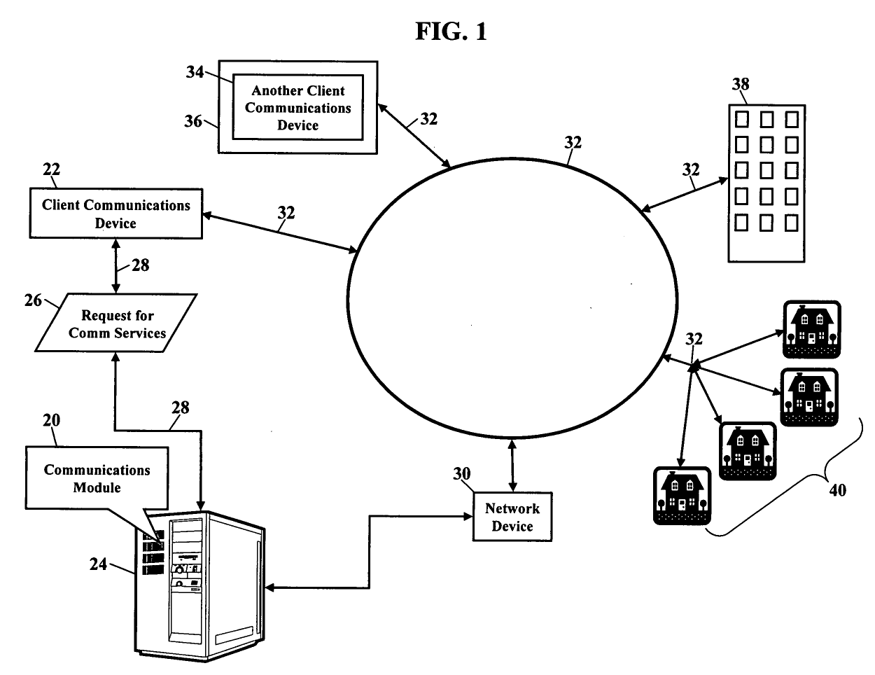

FIG. 1 is a simplified schematic illustrating the exemplary embodiments. A communications module 20 comprises methods, systems, computer programs, and/or computer program products that help provide communications services to a client communications device 22. The communications module 20 operates within a computer 24. The computer 24 receives a request 26 for communications services from the client communications device 22. When the client communications device 22 requires communications service, the term “communications service” means the client communications device 22 requests a data upload and/or a data download via a data/communications network. The term “data” includes electronic information, such as, for example, facsimile, electronic mail (e-mail), text, video, audio, and/or voice in a variety of formats, such as dual tone multi-frequency, digital, analog, and/or others. Additionally, the data may include: (1) executable programs, such as a software application, (2) an address, location, and/or other identifier of the storage location for the data, (3) integrated or otherwise combined files, and/or (4) profiles associated with configuration, authenticity, security, and others. The request 26 for communications services is received via a first physical medium 28 serving the client communications device 22. When the requested communications services exceeds the available bandwidth of the first physical medium 28, then the communications module 20 couples and/or logically bonds a second physical medium 32 to the client communications device 22. The logically bonded second physical medium 32 provides additional bandwidth to the client communications device 22.

As FIG. 1 shows, the second physical medium 32 may be dedicated or shared. That is, the second physical medium 32 is physically connected to the client communications device 22. The second physical medium 32 may also be connected to multiple, other destinations. These other destinations may include another client communications device 34 in another customer's premises 36. The second physical medium 32 may also be shared amongst multiple destinations within an office building 38 and/or within multiple residential customers in a neighborhood 40. Even though the second physical medium 32 may be shared amongst multiple destinations, the second physical medium 32 can be dynamically dedicated to a single destination when additional bandwidth is required. When the client communications device 22 requires communications services that exceed the available bandwidth of the first physical medium 28, then the second physical medium 32 may provide additional bandwidth. In the case where a third, fourth, or “n” number of circuits are required, additional physical media 32 can be physically and logically bonded to the client communications device 22. Data signals may then be transmitted to the client communications device 22 using the first physical medium 28, the second physical medium 32, and the “n” number of additional media. In general, the terms “second physical medium” and “additional media” represent any “n” number of physical and logical connections required to terminate on the client communications device 22 in order to provide adequate bandwidth for the desired service.

The second physical medium 32 is preferably bonded to the first physical medium 28. The terms “bond,” “bonded,” “bonding,” and other similar terms means the first physical medium 28 and the second physical medium 32 share the same session of information. When the client communications device 22 requires communications services via the first physical medium 28, the communications services are provided during Point-to-Point Protocol (PPP) session of information. That is, the client communications device 22 is logically connected to the first physical medium 28. When the available bandwidth of the first physical medium 28 cannot provide the requested communications services, the second physical medium 32 shares that same session of information. The first physical medium 28 and the second physical medium 32 are physically connected to the client communications device 22 and they share a single logical connection. The communications module 20 recognizes that the second physical medium 32 is now associated with the client communications device 22. The second physical medium 32 is dynamically added in terms of the capabilities of a service at the point when the client communications device 22 requires additional bandwidth. The client communications device 22 is thus served via the first physical medium 28 and with the bonded second physical medium 32.

The term “physical medium” implies a physical connection. Data signals are transmitted to/from the client communications device 22 via at least one physical connection. The first physical medium 28 and the second physical medium 32 may both be a twisted copper pair of wires, as is commonly found throughout many communications networks (such as the Public Switched Telephone Network). The first physical medium 28 and the second physical medium 32, however, may also include coaxial cable and/or fiber optic cable. The first physical medium 28 and second physical medium 32 may even include at least one of i) a combination of a twisted pair and a coaxial cable, ii) a combination of a twisted pair and a fiber optic cable, and iii) a combination of a coaxial cable and a fiber optic cable.

The network device 30 bonds the second physical medium 32. When the available bandwidth of the first physical medium 28 is exceeded, the communications module 20 instructs the network device 30 to logically bond the second physical medium 32 to the client communications device 22. The logically bonded second physical medium 32 provides additional bandwidth to the client communications device 22. The network device 30 can be a computing device that can execute instructions from the communications module 20. Some examples of the network device 30 may include an internet server, a content server, a gateway, a switch, a multiplexer, a modem, or any other device that can logically bond additional bandwidth.

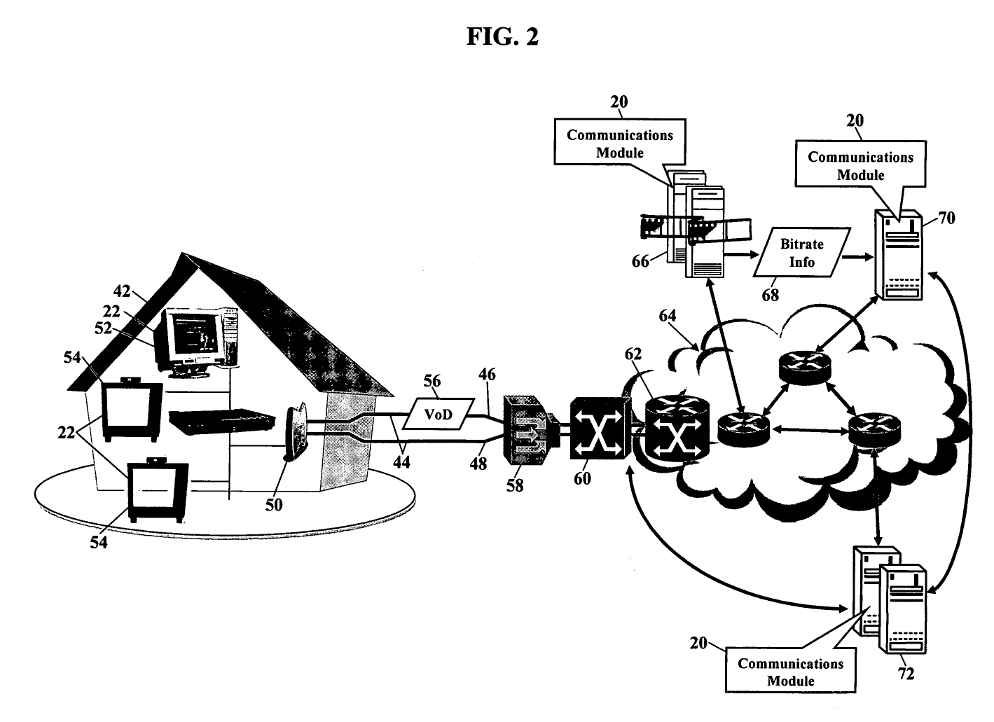

The exemplary embodiments are further illustrated by the following non-limiting example. FIG. 2 is a detailed schematic applying the exemplary embodiments in a Digital Subscriber Line (DSL) environment. As those of ordinary skill in the art understand, DSL uses twisted pair transmission lines to transmit high-bandwidth, high frequency signals. DSL is a transport medium for signals along a single twisted-wire pair. This twisted wire pair supports both message telecommunications service (e.g., Plain Old Telephone Service), full-duplex (simultaneous two-way), and simplex (from the network to a customer's installation) digital services. Because DSL is commonly available to residential customers and to business customers, this patent will not further discuss DSL technology. If, however, the reader desires more information on DSL technology, the reader is invited to consult AMERICAN NATIONAL STANDARDS INSTITUTE, Network to Customer Installation Interfaces—Asymmetric Digital Subscriber Line (ADSL) Metallic Interface (ANSI T1.413-1998) (1819 L Street NW, Washington, D.C. 20036, (202) 293-8020, www.ansi.org), and incorporated herein by reference in its entirety.

FIG. 2 shows a customer's premises 42. The customer's premises 42 are served by multiple physical media 44, such as a first twisted pair 46 and a second twisted pair 48. The multiple physical media 44 are shown connected to a residential gateway 50, such as a DSL modem, cable modem, router, or other access device. The residential gateway 50 provides an access interface to one or more of the customer's client communications devices 22. The customer may have multiple client communications devices 22 communicating via a home network with the residential gateway 50. FIG. 2, for example, shows the multiple client communications devices 22 as a computer 52 and one or more digital television devices 54 (including a television set-top box (STB)). The client communications devices 22, of course, could also include other computer devices (such as a laptop, desktop, tablet, server, and other computer systems), a personal digital assistant (PDA), a Global Positioning System (GPS) device, an Internet Protocol (IP) phone, a pager, a cellular/satellite phone, a modem, or any computer/communications device utilizing a digital signal processor (DSP).

The customer's client communications devices 22 requests communications services via the first twisted pair 46. Assume, for example, that one of the digital television devices 54 requests a download of video data (e.g., a video-on-demand service). A video-on-demand (VoD) request 56 is communicated via the first twisted pair 46 through a Digital Subscriber Line Access Multiplexer 58, through an asynchronous transfer mode (ATM) switch 60, through a broadband gateway 62, and into a primary ATM network 64. The video-on-demand request 56 routes along the ATM network 64 to the communications module 20 operating in the ATM network 64. FIG. 2 shows the communications module 20 operating in multiple computer devices within the ATM network 64, although those of ordinary skill in the art understand the communications module 20 may operate within a single computer device. The communications module 20 compares the bandwidth required to provide the requested video-on-demand service and the available bandwidth along the first twisted pair 46. The communications module 20 thus determines whether enough bandwidth is available to deliver the requested video over the first twisted pair 46 (e.g., a single DSL connection).

The video-on-demand request 56 routes along the ATM network 64 to a content server 66. This content server 66 may store some, or all, of the requested video data. The content server 66 determines the bitrate of the requested video data (e.g., 5 megabits per second of video data). The content server 66 then sends bitrate information 68 to a web server/service control computer device 70. If the available bandwidth is inadequate for a Quality of Presentation objective, the communications module 20 instructs a radius cluster 72 to arrange adequate bandwidth. The radius cluster 72 observes the configuration of the first twisted pair 46 and the configuration of the second twisted pair 74. The radius cluster 72 then instructs the Digital Subscriber Line Access Multiplexer (DSLAM) 58 to establish physical bonding with the second twisted pair 48. The radius cluster 72 also instructs the Digital Subscriber Line Access Multiplexer 58 to establish logical bonding of the Point-to-Point Protocol (PPP) session of information. The radius cluster 72 manages the logic on the broadband gateway 62, thus instructing the Digital Subscriber Line Access Multiplexer 58 to enable the bonding. Once the second twisted pair 48 is physically and logically bonded, the content server 66 may then transmit/deliver the requested video data content to the digital television device 54 via the Internet Protocol (IP) network 64. The physically and logically bonded second twisted pair 48 provides additional bandwidth to the digital television device 54.

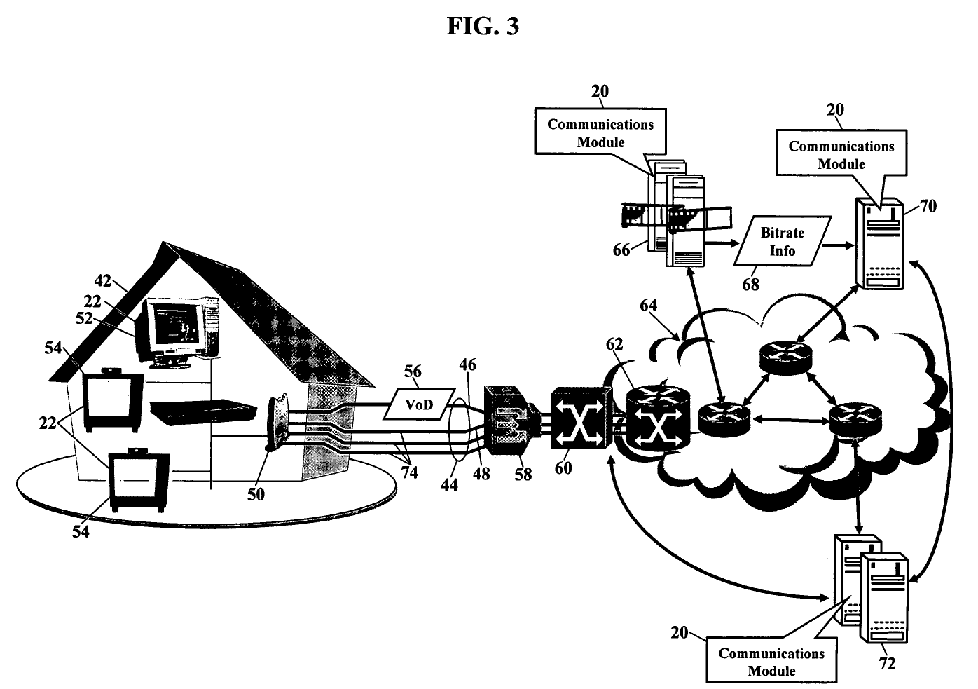

FIG. 3 is another detailed schematic applying the exemplary embodiments in a Digital Subscriber Line (DSL) environment. FIG. 3 is very similar to FIG. 2, except here the customer's premises 42 are served by n multiple physical media 44. That is, the when the requested communications service exceeds the available bandwidth of a primary twisted pair (such as the first twisted pair 46), the communications module 20 instructs the radius cluster 72 to arrange additional bandwidth. The radius cluster 72 again observes the configuration of the primary twisted pair. Here, however, the radius cluster 72 may observe the configuration of n multiple shared twisted pairs 74, where n denotes any integer. The radius cluster 72 can instruct the Digital Subscriber Line Access Multiplexer 58 to dynamically establish physical and logical bonding with n multiple shared twisted pairs 74. These n multiple shared twisted pairs 74 provide n bonded PPP sessions to dynamically provide as much bandwidth as the customer might require.

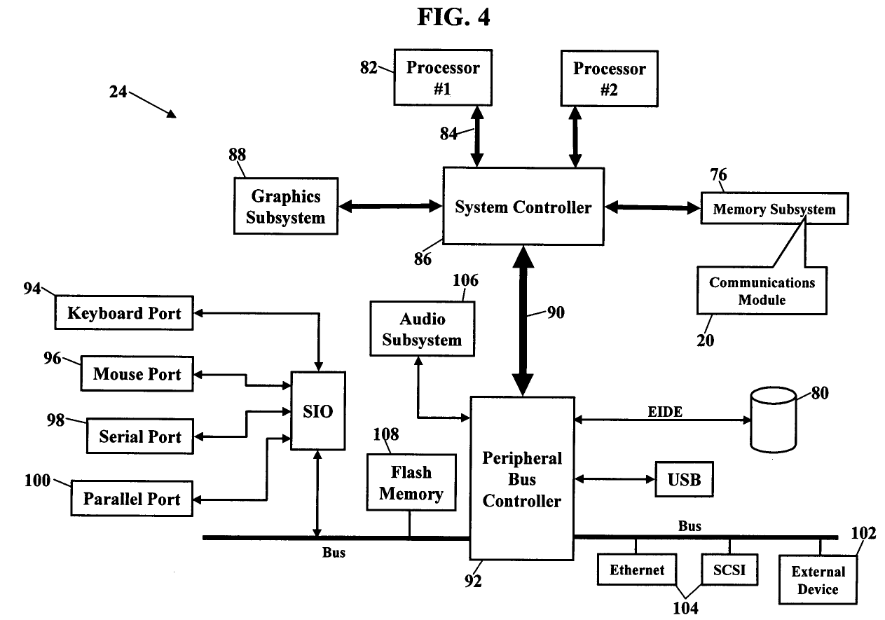

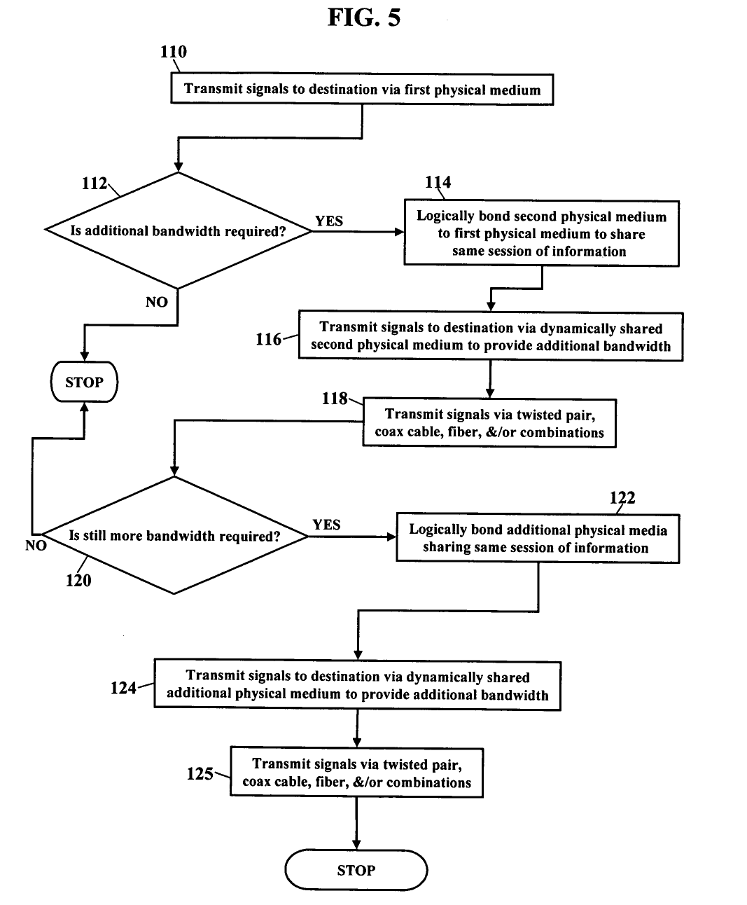

FIG. 4 is a block diagram showing the communications module 20 residing in the computer system 24. The computer system 24 may be any computing device, and the computer system 24 may include the content server, the web server/service control computer device, the radius cluster, or the Digital Subscriber Line Access Multiplexer (shown, respectively, as reference numerals 66, 70, 72, and 58 in FIGS. 2 and 3). The communications module 20 operates within a system memory device. The communications module 20, for example, is shown residing in a memory subsystem 76. The communications module 20, however, could also reside in flash memory 78 or peripheral storage device 80. The computer system 24 also has one or more central processors 82 executing an operating system. The operating system, as is well known, has a set of instructions that control the internal functions of the computer system 24. A system bus 84 communicates signals, such as data signals, control signals, and address signals, between the central processor 82 and a system controller 86 (typically called a “Northbridge”). The system controller 86 provides a bridging function between the one or more central processors 82, a graphics subsystem 88, the memory subsystem 76, and a PCI (Peripheral Controller Interface) bus 90. The PCI bus 90 is controlled by a Peripheral Bus Controller 92. The Peripheral Bus Controller 92 (typically called a “Southbridge”) is an integrated circuit that serves as an input/output hub for various peripheral ports. These peripheral ports are shown including a keyboard port 94, a mouse port 96, a serial port 98 and/or a parallel port 100 for a video display unit, one or more external device ports 102, and networking ports 104 (such as SCSI or Ethernet). The Peripheral Bus Controller 92 also includes an audio subsystem 106. Those of ordinary skill in the art understand that the program, processes, methods, and systems described in this patent are not limited to any particular computer system or computer hardware.

Those of ordinary skill in the art also understand the central processor 82 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 76, flash memory 108, or peripheral storage device 80) may also contain an application program. The application program cooperates with the operating system and with a video display unit (via the serial port 98 and/or the parallel port 100) to provide a Graphical User Interface (GUI). The Graphical User Interface typically includes a combination of signals communicated along the keyboard port 94 and the mouse port 96. The Graphical User Interface provides a convenient visual and/or audible interface with a user of the computer system 24.

The exemplary embodiments may be applied to other environments. When requested communications services exceed the available bandwidth of a primary first physical medium serving a customer's premises, and/or a client communications device, the exemplary embodiments physically and logically bond n multiple, additional physical mediums. The bonded n multiple, additional physical mediums provide additional bandwidth when necessary. Because the term “physical medium” implies a physical connection, the exemplary embodiments are not limited to Digital Subscriber Line environments. The exemplary embodiments may be applied to a generic physical infrastructure, such as a fiber plant, a copper plant, a coaxial cable plant, and hybrid versions/combinations of each. Because the exemplary embodiments may be applied to other physical infrastructures, these other physical infrastructures need not require the Digital Subscriber Line Access Multiplexer, the asynchronous transfer mode (ATM) switch, and the broadband gateway (shown, respectively, as reference numerals 58, 60, and 62 in FIGS. 2 and 3). These other physical infrastructures may require additional and/or alternative equipment, as those of ordinary skill in the art will recognize.

The exemplary embodiments, for example, could be applied to the coaxial cable industry. Whereas FIGS. 2 and 3 show the customer's premises 42 being served by n multiple twisted pairs, the customer's premises could be served by n multiple coaxial cables. These n multiple coaxial cables would be the multiple physical media providing media content to the customer's premises 42. When the customer's requested communications services exceed the available bandwidth of a primary coaxial cable serving a customer's premises, and/or a client communications device, then the exemplary embodiments physically and logically bond n multiple, additional coaxial cables. The logically bonded n multiple, additional coaxial cables provide additional bandwidth when necessary. While there are many devices used within the coaxial cable infrastructure that could physically/logically bond the n multiple, additional coaxial cables, a cable modem termination system (CMTS) is one example.

The exemplary embodiments may also be applied to a fiber optic infrastructure. Because the cost of an all-fiber infrastructure is expensive, and because a fiber optic media can transmit/transport much more information/signals, one or more shared fiber optic lines could be more economically feasible. A customer's premises could be served by n multiple fiber optic lines, and these fiber optic lines could also be shared by other customers. When one customer's requested communications services exceed the available bandwidth of a primary physical media (such as a DSL, a coaxial cable, and/or a fiber optic line), then the exemplary embodiments could physically and logically bond one or more fiber optic lines to the customer's session. The logically bonded fiber optic lines provide additional bandwidth when necessary. This fiber infrastructure, for example, might utilize an Optical Network Unit (ONU) to physically/logically bond one or more fiber optic lines to the customer's session.

The exemplary embodiments provide added benefits. Because the customer's premises are served by multiple physical media, these bonded media provide redundancy. As the years pass, the physical and performance properties of the physical media may degrade. Because, however, the customer has access to multiple physical media, the exemplary embodiments provide greater statistical probabilities for successful transmissions of data signals. Because the customer, again, has access to multiple physical media, there is less of a chance that the customer will lose all communications service during storms and catastrophes. Should one of the physical mediums be severed or disabled, the other physical media provide redundant communications paths.

The exemplary embodiments provide still more benefits. Because the exemplary embodiments utilize multiple physical mediums, each individual medium could be dedicated to a particular format. The primary physical medium, for example, might be dedicated to a specific service (such as standard Internet traffic) and/or a particular range of frequencies. An additional, shared medium might be reserved for higher bandwidth requirements (such as MPEG1/2/3/4 content) and/or higher frequency signals.

FIG. 5 is a flowchart illustrating a method of providing communications services. Signals are transmitted to a destination via a first physical medium (Block 110). If additional bandwidth is required (Block 112), a second physical medium is logically bonded to the first physical medium (Block 114), such that first physical medium and the second physical medium share the same session of information. Signals are then transmitted to the destination via the second physical medium (Block 116). The second physical medium is dynamically shared amongst multiple destinations to provide additional bandwidth when required. Signals may be transmitted via a twisted pair, via a coaxial cable, via a fiber optic cable, and/or via hybrid combinations, such as i) a combination of a twisted pair and a coaxial cable, ii) a combination of a twisted pair and a fiber optic cable, and iii) a combination of a coaxial cable and a fiber optic cable (Block 118). If additional bandwidth is still required (Block 120), additional physical media can be logically bonded (Block 122). Each additional physical media is dynamically shared amongst the multiple destinations to provide additional bandwidth. Signals are then transmitted to the destination via the first physical medium and the second physical medium, thus sharing the same session of information (Block 124). When the signals are transmitted to the destination, the signals may be transmitted via twisted pair, coaxial cable, fiber optic cable, and hybrid combinations (Block 125).

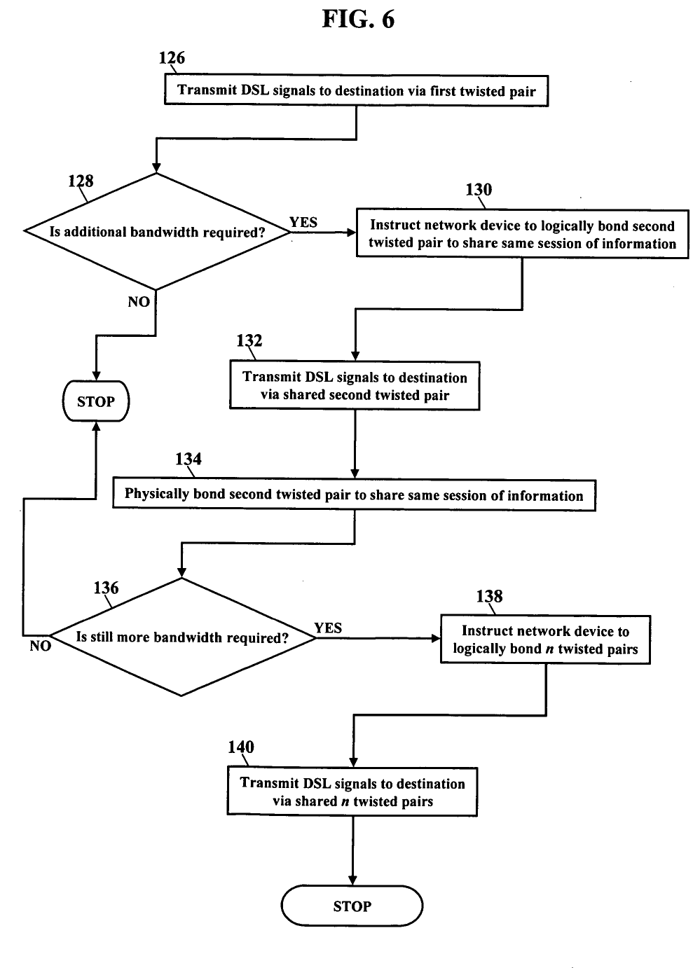

FIG. 6 is a flowchart illustrating another method of providing communications services. Digital Subscriber Line (DSL) signals are transmitted to a destination via a first twisted pair (Block 126). If additional bandwidth is required (Block 128), a network device is instructed to logically bond a second twisted pair and the first twisted pair (Block 130), such that first twisted pair and the second twisted pair share the same session of information. Digital Subscriber Line signals are then transmitted to the destination via the second twisted pair (Block 132). The second twisted pair is shared amongst the destination and another destination, and the second twisted pair provides additional bandwidth when required. The second twisted pair may be physically bonded to the first twisted pair (Block 134), such that first twisted pair and the second twisted pair share the same session of information. If additional bandwidth is still required (Block 136), the network device is instructed to logically bond a third twisted pair to the destination (Block 138). The third twisted pair is shared amongst the destination and another destination, and the third twisted pair provides additional bandwidth when required. If additional bandwidth is still required (Block 140), the network device is instructed to logically bond n additional twisted pairs to the destination (Block 142). The n additional twisted pairs are shared amongst the destination and another destination, and the n additional twisted pairs provide additional bandwidth when required. Digital Subscriber Line signals are then transmitted to the destination via the twisted pairs (Block 144).

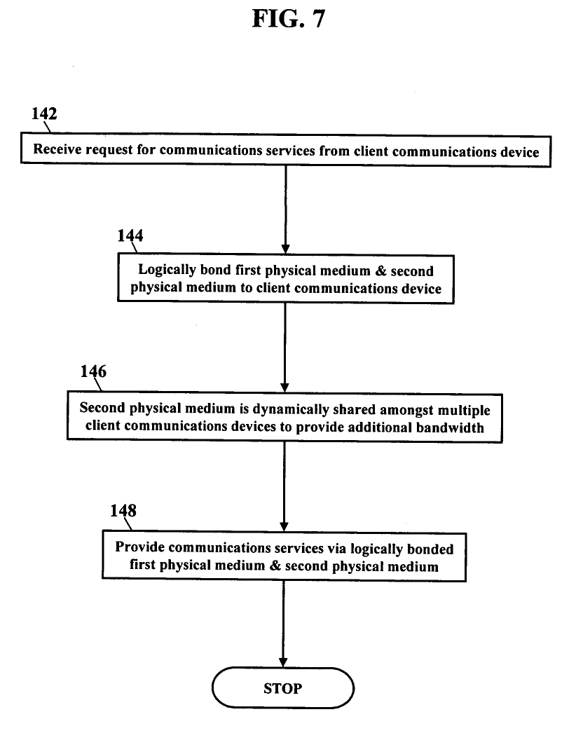

FIG. 7 is a flowchart illustrating yet another method of providing communications services. A request for communications services is received from a client communications device (Block 142). A first physical medium and a second physical medium are logically bonded to the client communications device (Block 144). The second physical medium is dynamically shared amongst multiple client communications devices to provide additional bandwidth when required (Block 146). The communications services are then provided via the logically bonded first physical medium and the second physical medium (Block 148).

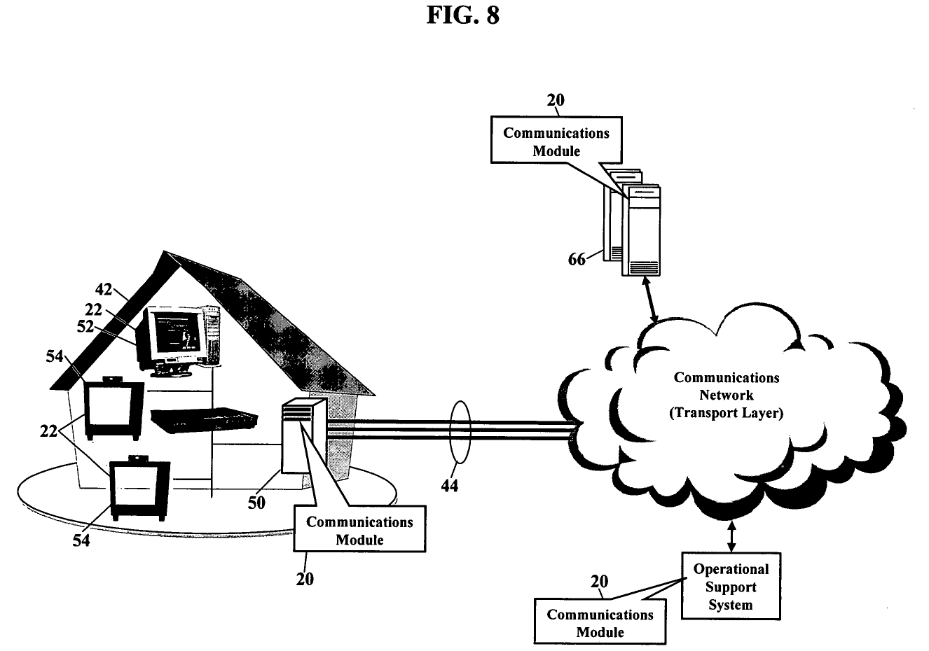

FIG. 8 is a schematic illustrating on-demand management of bonded physical mediums, according to more exemplary embodiments. Regardless of how many physical mediums may serve the client communications devices 22 (or any destination), the logical bonding of those physical mediums must be managed. Here, then, the communications module 20 also provides a feedback mechanism. This feedback mechanism monitors when requested bit rates exceed currently available bit rates. When a customer's requested content or programming requires a greater bit rate than can be provided, the feedback mechanism informs the customer of this discrepancy. The feedback mechanism may also provide the customer with alternatives that remain within the capabilities of the communications network.

FIG. 8 illustrates this feedback mechanism. Here, multiple instances of the communications module 20 may operate within the client communications device 22 (such as the residential gateway 50), within an operational support system 150 for the multiple physical mediums 44, and within the content server 66. The communications module 20 monitors requested bit rates and compares the requested bit rates to available bit rates. When a customer requests programming or content, the communications module 20 arbitrates between the capabilities of the physical mediums 44, the operational support system 150, and the residential gateway 50 to provide that requested bit rate. Should the requested bit rate exceed the available bit rate, then the communications module 20 may provide alternatives. The feedback mechanism, however, has already been described in a related application, so the feedback mechanism will not be further discussed. If the reader desires a greater explanation, the reader is invited to consult the co-pending and commonly assigned U.S. patent application Ser. No. 11/223,604, filed Sep. 9, 2005, entitled “Methods for Providing Communications Services” (Attorney Docket BS01098 CIP), and incorporated herein by reference in its entirety.

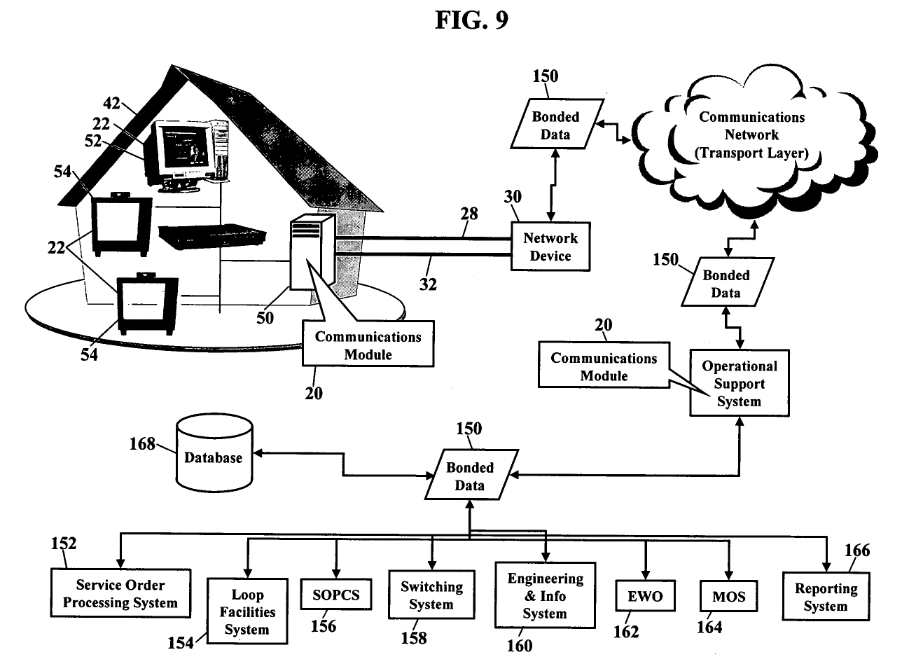

FIG. 9 is a schematic illustrating another operating environment for exemplary embodiments. Here, when two or more physical mediums are bonded, any supporting computer and database systems must associate the bonded relationship. That is, any database that maintains records associated with either medium must now make an association. In the communications industry, each medium is generically termed a “facility.” So when two or more facilities are bonded, any supporting software applications must understand, record, and maintain that bonded association.

FIG. 9 provides an example. Recall that when a subscriber's requested communications service exceeds the available bandwidth of the first physical medium 28, then the communications module 20 instructs the network device 30 to logically bond the second physical medium 32 to provide additional bandwidth. The communications module 20 may instruct the network device 30 to select a particular pairing, or the network device 30 may make its own selection. However the first physical medium 28 is bonded to the second physical medium 32, that bonded relationship is passed along to one or more supporting computers, software applications, and/or database systems. FIG. 9 illustrates that bonded data 150 is shared between the network device 30 and the communications module 20. The bonded data 150 describes the bonded relationship between the first physical medium 28 and the second physical medium 32.

FIG. 9 also illustrates other systems that receive or maintain the bonded data 150. The bonded data 150 may be communicated to, received by, or stored in a service order processing system 152. The service order processing system 152 generically represents any software application or computer system(s) that create, issue, or manage service orders and/or maintenance orders. The bonded data 150 may be communicated to, received by, or stored in a loop facilities system (such as Tekmark's LFACS) 154. The bonded data 150 may be communicated to, received by, or stored in a service order parser and controller system (SOPCS) 156. The bonded data 150 may be communicated to, received by, or stored in a switching system 158 (such as Telcordia's SWITCH® system). The bonded data 150 may be communicated to, received by, or stored in an engineering and information system 160 (such as Telcordia's LEIS®). The bonded data 150 may be communicated to, received by, or stored in an engineering work order (EWO) system 162. The bonded data 150 may be communicated to, received by, or stored in a maintenance operations system (MOS) (such as Telcordia's LMOS®) 164. The bonded data 150 may be communicated to, received by, or stored in a reporting system 166. Because the loop facilities system 154, the service order parser and controller system 156, the switching system 158, the engineering and information system 160, EWO system 162, the maintenance operations system 164, and the reporting system 166 are well known, this specification will not further describe such systems.

FIG. 9 also illustrates a database 168. The database 168 represents any software application or computer system that receives any information regarding a bonded relationship between physical mediums. The bonded data 150 may be sent to, communicated to, or shared with the database 168. The database 168, for example, may be any memory or storage device in a communications network that receives the bonded data 150. Whatever information the database 168 stores, the database 168 associates two mediums (or facilities or circuits, as will be explained) that were heretofore never associated. That is, heretofore two separate lines were never associated in these systems. Exemplary embodiments, additionally, maintain that relationship between those facilities.

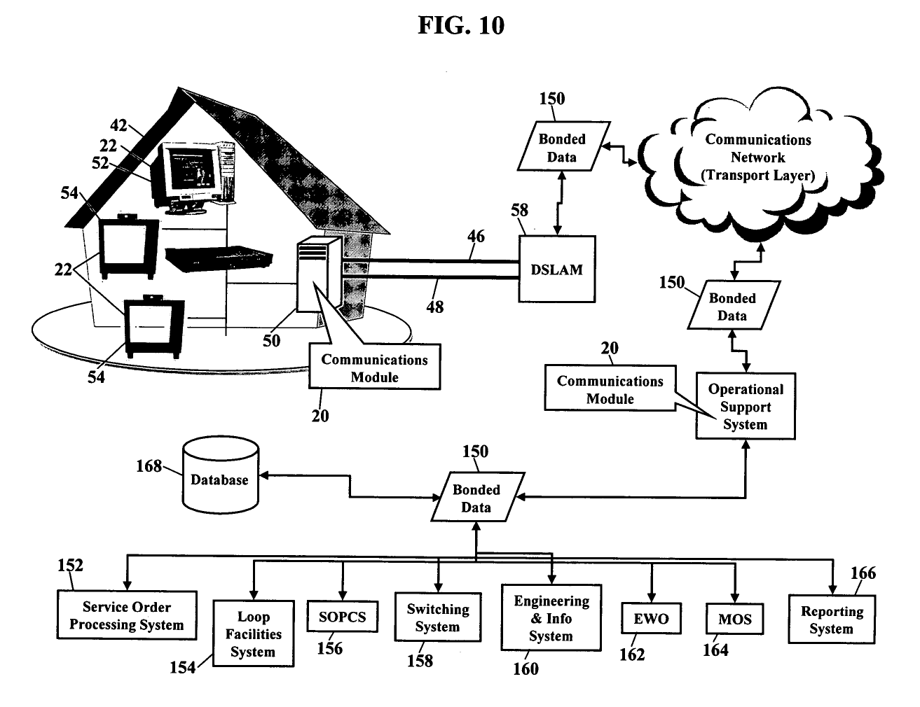

FIG. 10 is another schematic illustrating a Digital Subscriber Line (DSL) environment, according to more exemplary embodiments. Here exemplary embodiments describe concepts or modifications to various facilities management systems that associate and maintain the bonded relationship between two or more digital subscriber lines. When two or more digital subscriber lines are bonded, any supporting computer and database systems must associate the bonded relationship. That is, records associated with either digital subscriber line must now make an association. In the communications industry, each digital subscriber line is generically termed a “facility.” So when two or more digital subscriber lines are bonded, any management software application must understand, record, and maintain that bonded association throughout a facilities management system.

FIG. 10 provides an example. When bonded digital subscriber lines, or facilities, are needed, the Digital Subscriber Line Access Multiplexer (DSLAM) 58 must identify what ports or cable pairs are capable of being bonded. Recall that when a subscriber requests data that exceeds the bandwidth capability of the first twisted pair 46 (e.g., the single DSL connection), the communications module 20 instructs the Digital Subscriber Line Access Multiplexer (DSLAM) 58 to establish physical and/or logical bonding with the second twisted pair 48. Before the DSLAM 58 can establish this bonding, however, the DSLAM 58 must know what ports are capable of being bonded.

Exemplary embodiments, then, may identify like facilities. There may be different types of DSLAM facilities, and not all of them are compatible or capable of being bonded. Exemplary embodiments, then, may identify those DSLAM ports, or DSLAM pairs, that are capable of being bonded. Once the capable ports are known, the DSLAM 58 then selects two of those ports for bonding and identifies those facilities for new assignments in the loop facilities system 154. While the DSLAM 58 may select any two ports, a first phase implementation of bonding may select two adjacent ports for bonding. These adjacent ports may have consecutive numerical designations, such that one port is an odd number and another port is an even number. Future implementations, however, will support bonding of any ports, not just adjacent ports, and thus the ports may have any number designation. Hardware boards or cards may be installed within the DSLAM 58 that distinguish between implementations, such that first phase cards support adjacent bonding, while phase two cards support system-level bonding of any ports. Whatever the implementation, when the communications module 20 determines that bonding is desired, the DSLAM 58 selects the proper ports that are capable of bonding.

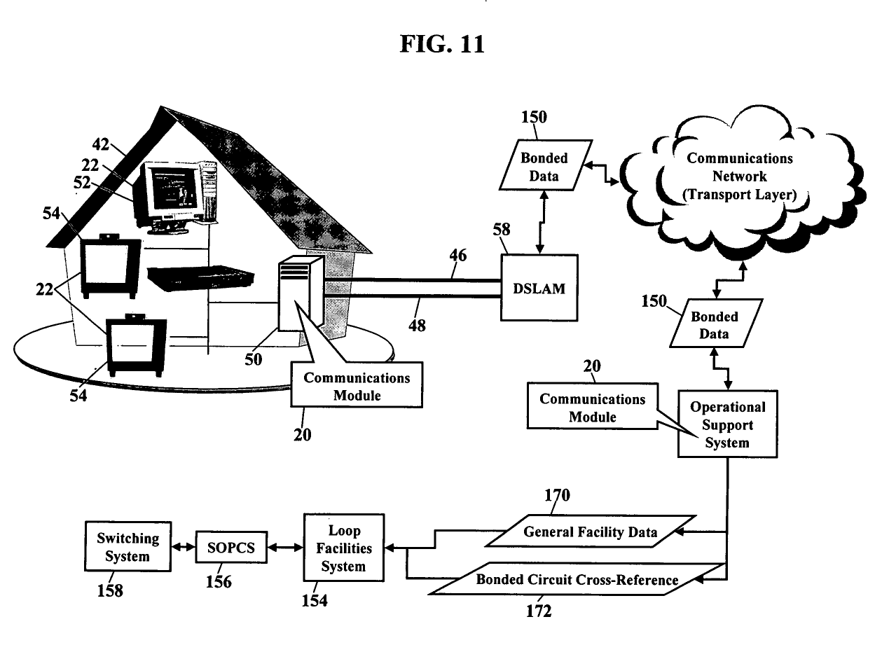

FIG. 11 is a schematic illustrating a bonded association in a service order process, according to still more exemplary embodiments. As a service order is created and/or developed, the service order must recognize and associate the bonded relationship between two or more physical media. FIG. 11, then, illustrates enhancements to the loop facilities system 154, the service order parser and controller system 156, and/or to the switching system 158. The loop facilities system 154, for example, receives a general facility data feed 170 and a bonded circuit cross-reference (BCCR) 172. The general facility data feed 170 identifies a bonded facility, and the BCCR 172 identifies the bonded mating facility or circuit. The loop facilities system 154 then passes, supplies, or communicates the general facility data feed 170 and the BCCR 17 to the service order parser and controller system (SOPCS) 156 and/or to the switching system 158. The loop facilities system 154, the service order parser and controller system 156, and the switching system 158, then, are enhanced to accept and to process the general facility data feed 170 and the BCCR 172. The loop facilities system 154, the service order parser and controller system 156, and the switching system 158 are thus one or more databases that associate, cross-reference, and/or maintain a relationship between the bonded facilities.

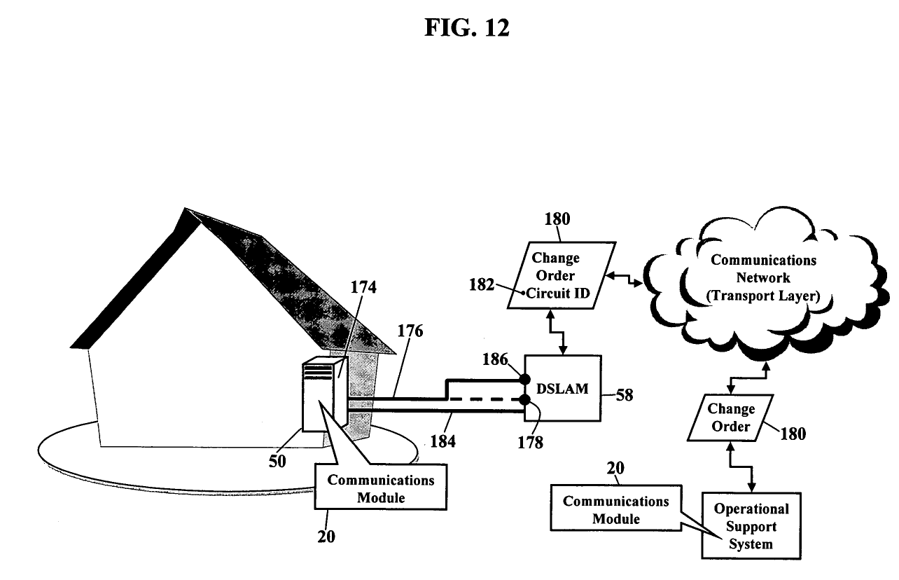

FIG. 12 is a schematic illustrating provisions for facility optimization, according to even more exemplary embodiments. When bonding is desired, existing facilities may be reused to provide the bonded relationship. That is, FIG. 12 illustrates that an existing subscriber's digital subscriber line may be “cut” and made available for bonding, based on a bandwidth requirement. The existing subscriber is then assigned another facility. So exemplary embodiments modify any existing software algorithms to permit reassignment of facilities and line station transfers. Exemplary embodiments, then, optimize facility utilizations that reduce, or even eliminate, requests for manual assistance.

FIG. 12 illustrates an existing DSL subscriber 174. The existing DSL subscriber 174 is serviced by a digital subscriber line 176 from the Digital Subscriber Line Access Multiplexer (DSLAM) 58. Because the communications module 20 monitors bandwidth requirements, the communications module 20 may determine that the digital subscriber line 176 could be better utilized for another subscriber. (It may be that the subscriber is only paying for reduced data rate DSL service, so the digital subscriber line 176 can be reassigned without affecting the subscriber's subscription). If a port 178 at the DSLAM 58 can be reused and/or reassigned for bonded DSL service, a change order 180 may issue. The change order 180 adds a circuit identification 182 to bond the digital subscriber line 176 with a second digital subscriber line 184. That is, the cable pairs 176 and 184 are assigned at the DSLAM 58. FIG. 12, then, illustrates enhanced cut processing in which the digital subscriber line 176 is moved from its old port 178 to new port 186 at the DSLAM 58. The existing DSL subscriber is still provided DSL service, but the subscriber's old port 178 is reassigned as a bonded pair, thus optimizing facility utilizations.

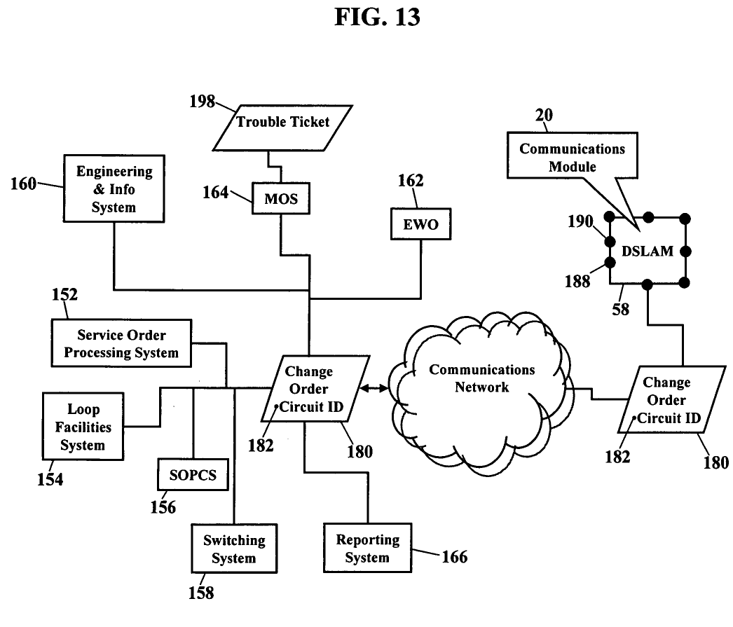

FIG. 13 is a schematic illustrating provisions for facility optimization, according to even more exemplary embodiments. Here, when one bonded port 188 in the Digital Subscriber Line Access Multiplexer (DSLAM) 58 must be reassigned, exemplary embodiments may automatically change the mating, second, bonded port 190. Recall that first phase implementations assign bonded pairs to consecutive odd-even numbered ports in the DSLAM 58. If any port change is made to one mate of a bonded facility pair, then exemplary embodiments may automatically change the associated second mate to maintain consecutive odd-even numbered ports in the DSLAM 58. Suppose, for example, that one facility DSL pair is found defective. When a technician reports the defective pair, a new pair is assigned. Exemplary embodiments, however, enhance the current facilities management systems so that the bonded mate is reassigned to a new port in the DSLAM 58. The new port assignment maintains the first phase consecutive odd-even numbered pairing. Second phase implementations, however, may not utilize this odd-even numbering, as earlier explained. This facility optimization is applicable to changes to pending service order activity as well as changes to existing service.

FIG. 13, then, illustrates both service order changes and MCT changes. When a port change is made to one mate of a bonded facility pair, then exemplary embodiments may automatically change the associated second mate. The change order 180 issues, and the change order 180 includes the circuit identification 182 of the bonded mate. The change order 180 communicates to any of the service order processing system 152, the loop facilities system 154, the service order parser and controller system 156, the switching system 158, the engineering and information system 160, the engineering work order (EWO) system 162, and/or the maintenance operations system 164.

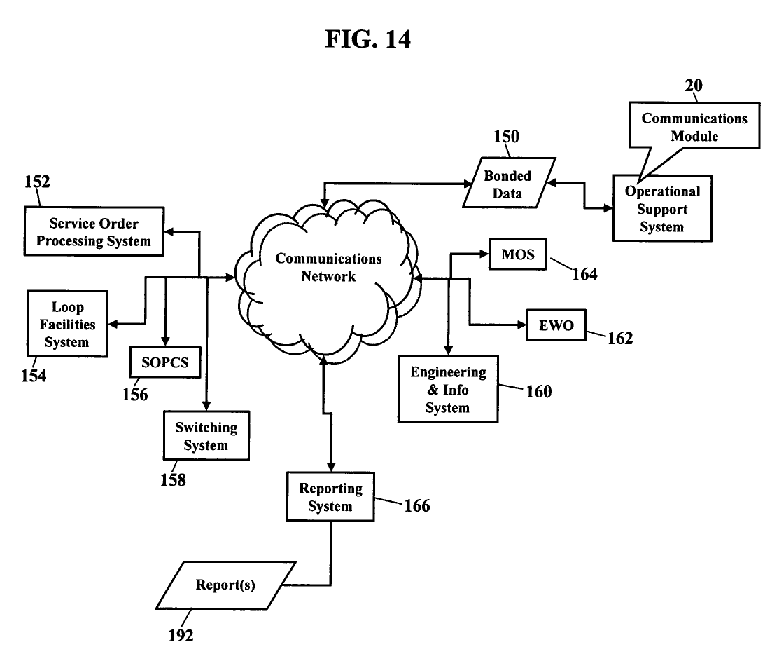

FIG. 14 is a schematic illustrating provisions for identifying spare facilities, according to exemplary embodiments. Here, the reporting system 166 creates one or more reports 192 that identify available bonded mates. These reports 192 may originate or generate from the service order processing system 152, the loop facilities system 154, the service order parser and controller system (SOPCS) 156, the switching system 158, the engineering and information system 160, the engineering work order (EWO) system 162, and/or the maintenance operations system (MOS) 164. The reporting system 166 may be a software module that provides a status or “snapshot” of any data received by, monitored by, or output by the service order processing system 152, the loop facilities system 154, the service order parser and controller system 156, the switching system 158, the engineering and information system 160, the EWO system 162, and/or the maintenance operations system 164. When any system generates the reports 192, those reports 192 identify the bonded, mating facilities. That is, the systems not only indicate a facility is bonded, but the reports 192 also identify what facility pairs are bonded together. The reports 192 may count or total the number of bonded mates, rather than simply provide a listing of bonded pairs or a total quantity of ports. Because the reports 192 identify pairs of ports that are bonded together, other operations may be more efficient. For example, if engineering, cutover, or transfer work is required, not only may are bonded ports identified, but, more specifically, the bonded, mating pairs are identified. As work is planned, the identified bonded ports can be quickly identified and engineering work is more efficient.

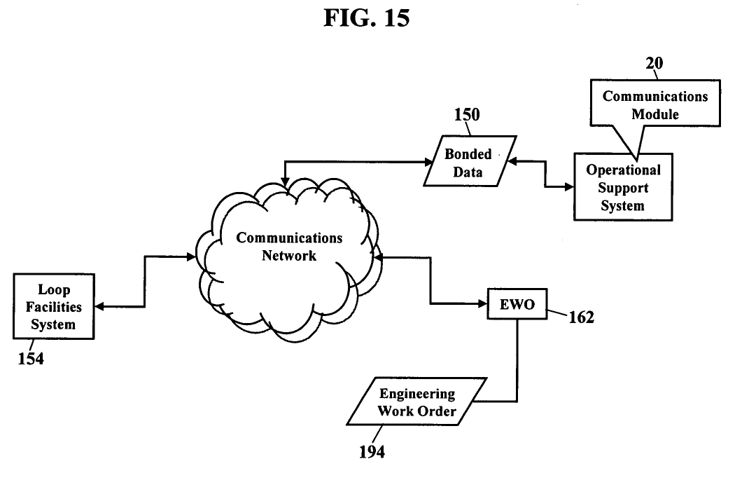

FIG. 15 is a schematic illustrating provisions for maintaining bonded facilities in the engineering work order system 162, according to even more exemplary embodiments. Here, when two or more facilities are bonded, that bonded association is identified and maintained in the engineering work order system 162. When an engineering work order (or “job”) 194 is authorized, the bonded relationship is identified to engineers, field technicians, and any others. Suppose, for example, engineers need to rearrange an area where bonded facilities are served. During that rearrangement planning process, the bonded facility mates are identified and reported. When the engineering work order 194 (or job authorization) is generated, the engineering work order 194 identifies the rearrangements and identifies any bonded facilities that are involved in that rearrangement. So, as algorithms in the loop facilities system 154 and in the EWO system 162 process the rearrangement, the bonded pairs are recognized. The loop facilities system 154 and the EWO system 162, thus, understand, identify, retain, and output any bonded associations.

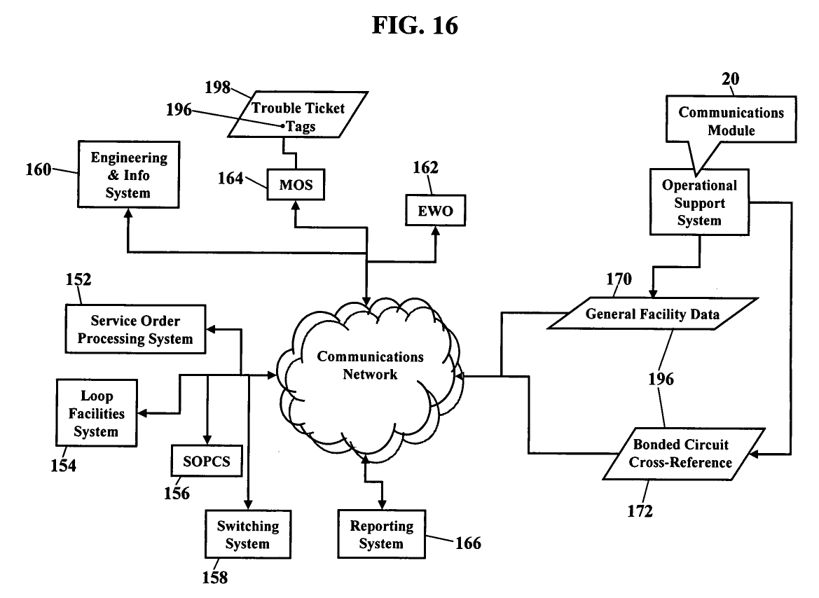

FIG. 16 is a schematic illustrating provisions for tagging bonded facilities, according to still more exemplary embodiments. Recall that the loop facilities system 154 receives the general facility data feed 170 and the bonded circuit cross-reference (BCCR) 172 (as explained in more detail with reference to FIG. 11). Here, the general facility data feed 170 and the BCCR 172 are also communicated to any supporting systems that may make use of the information. The general facility data feed 170 and the BCCR 172, for example, are communicated to the service order processing system 152, the loop facilities system 154, the service order parser and controller system 156, the switching system 158, the engineering and information system 160, the engineering work order (EWO) system 162, and/or the maintenance operations system 164. When a subscriber reports trouble on their line, the maintenance operations system 164, for example, provides the field technician a line record of the subscriber's facilities. Because the maintenance operations system 164 receives the general facility data feed 170 and the BCCR 172, the maintenance operations system 164 generates a service order with bonded associations. The general facility data feed 170 and the BCCR 172 are thus simply referred to as “tags” 196. The tags 196 are markers, flags, or identifiers that identify bonded, mating associations. When the field technician receives a trouble ticket 198, the tags 196 quickly and easily identify bonded mates. As the field technician resolves the subscriber's trouble, the field technician is less likely to disassociate the bonded mates. Moreover, the tags 196 help the field technician take measures to maintain bonded associations.

The communications module 20 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the communications module 20 to be easily disseminated. A computer program product for associating and maintaining bonded relationships includes the communications module 20 stored on the computer-readable medium. The communications module 20 includes computer-readable or computer-implemented instructions for associating and maintaining bonded relationships.

The communications module 20 may also be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of providing communications services, comprising the steps of:
logically bonding at least a first physical medium and a second physical medium; and
associating the logically bonded first physical medium and the second physical medium in a database.

2. A method according to claim 1, wherein the step of logically bonding comprises bonding the first physical medium and the second physical medium at a Digital Subscriber Line Access Multiplexer.

3. A method according to claim 1, further comprising the step of maintaining the association between the first physical medium and the second physical medium in a service order processing system.

4. A method according to claim 1, further comprising the step of maintaining the association between the first physical medium and the second physical medium in a loop facilities system.

5. A method according to claim 1, further comprising the step of maintaining the association between the first physical medium and the second physical medium in a switching system.

6. A method according to claim 1, further comprising the step of maintaining the association between the first physical medium and the second physical medium in an engineering and information system.

7. A method according to claim 1, further comprising the step of reporting the bonded association between the first physical medium and the second physical medium.

8. A system, comprising:
a communications module stored in memory; and
a processor communicating with a user interface stored in memory,
the processor logically bonding at least a first physical medium and a second physical medium; and
the processor associating the logically bonded first physical medium and the second physical medium in a database.

9. A system according to claim 8, wherein the processor bonds the first physical medium and the second physical medium at a Digital Subscriber Line Access Multiplexer.

10. A system according to claim 8, wherein the processor maintains the association between the first physical medium and the second physical medium in a service order processing system.

11. A system according to claim 8, wherein the processor maintains the association between the first physical medium and the second physical medium in a loop facilities system.

12. A system according to claim 8, wherein the processor maintains the association between the first physical medium and the second physical medium in a switching system.

13. A system according to claim 8, wherein the processor maintains the association between the first physical medium and the second physical medium in an engineering and information system.

14. A system according to claim 8, wherein the processor reports the bonded association between the first physical medium and the second physical medium.

15. A computer program product comprising computer-readable instructions for performing the steps:
logically bonding at least a first physical medium and a second physical medium; and
associating the logically bonded first physical medium and the second physical medium in a database.

16. A computer program product according to claim 15, further comprising computer instructions for bonding the first physical medium and the second physical medium at a Digital Subscriber Line Access Multiplexer.

17. A computer program product according to claim 15, further comprising computer instructions for maintaining the association between the first physical medium and the second physical medium in a service order processing system.

18. A computer program product according to claim 15, further comprising computer instructions for maintaining the association between the first physical medium and the second physical medium in a loop facilities system.

19. A computer program product according to claim 15, further comprising computer instructions for maintaining the association between the first physical medium and the second physical medium in a switching system.

20. A computer program product according to claim 15, further comprising computer instructions for maintaining the association between the first physical medium and the second physical medium in an engineering and information system.
